(19) United States
(12) Patent Application Publication
(10) Pub. No.: US 2025/0301962 A1
(43) Pub. Date: Oct. 2, 2025

(54) FOLDABLE STACKABLE STORAGE PLANTER BOX STRUCTURE

(71) Applicant: Ting-Chih LIN, Yilan County (TW)

(72) Inventor: Ting-Chih LIN, Yilan County (TW)

(21) Appl. No.: 18/617,687

(22) Filed: Mar. 27, 2024

(51) Int. Cl. A01G 9/02

(52) U.S. Cl. CPC A01G 9/026

(57) ABSTRACT

A foldable stackable storage planter box structure includes a box with a base, two side panels, and two end panels. Two sides of the base are connected to the side panels. Two ends of the base are equipped with the end panels. The base has penetrating drainage holes for permeating water, bottom snap recesses at four corners of the bottom of the base, and at least one side snap protrusion and at least one end snap protrusion on two sides and two ends of the base respectively; a support stand at top of the base of the box and on the inner side of the vertical side panel and end panel and having through holes for permeating water and lower supports at bottom of the support stand for supporting the base and defining a space; and at least one filter fabric at the top of the support stand.

### BACKGROUND OF THE DISCLOSURE

### Technical Field

The present disclosure relates to a planter box, more particularly relates to a foldable stackable storage planter box structure that provides a planter box having a support stand and a filter fabric installed in the box and the box can be folded and stacked on a number of other boxes.

### Description of the Related Art

The structure of a traditional planter box (such as a flowerpot) generally comes with a huge space, so that it requires a lot of space for transportation, resulting in increased costs and inconvenience of transportation. In addition, the structure of the traditional planter box cannot be stacked with one another, so that the application of the planter boxes cannot be arranged in a neat manner, and the bottom of the planter box is only equipped with a small hole in the planter box, and the soil contained in the planter box is in a direct contact with the bottom of the planter box, and thus such planter box does not provide adequate space for permeating air and water. Furthermore, the traditional planter box cannot be folded when it is not in use, resulting in poor storage and low practicality. The foregoing drawbacks of the traditional planter box are the issues that manufacturers of the related industry and consumers want to break through.

### SUMMARY OF THE DISCLOSURE

In view of the aforementioned drawbacks the related art, it is a primary objective of the present disclosure to overcome the drawbacks of the related art by providing a foldable stackable storage planter box structure with a base, its two sides and two ends are movably connected to a side panel and an end panel, the top of the side panel and the top of the end panel are provided with a side top recess and an end top recess respectively, and the two sides and two ends of the base are provided with a side snap protrusion and an end snap protrusion respectively, and the top of the base is provided a support stand, and the top of the support stand is provided with a filter fabric, in hope of overcoming the technical issues of the related art.

A secondary objective of the present disclosure is to provide a foldable stackable storage planter box structure with the end panel and side panel folded inwardly or outwardly in a vertical manner and combined to provide a folded flat box or a vertically unfolded box. The box provides a space for placing a support stand and a filter fabric, and uses a side top recess of the side panel and an end top recess of the end panel to interconnect a side snap protrusion and an end snap protrusion formed at the bottom of another box.

Another objective of the present disclosure is to provide a foldable stackable storage planter box structure to effectively enhance the ease of use, save space, and provide good transportation, storage and stacking stability.

The problem intended to be solved by the present disclosure is that the traditional common planter box (e.g., a flowerpot) generally comes with a fixed structure with a huge space, so that it is necessary to prepare and provide a large space for its transportation, resulting in increased costs and inconvenience of transportation, and its structure cannot be stacked after planting, and the use of cannot be neatly arranged, and its bottom only equipped with a small hole and the soil contained in the box is in direct contact with the bottom, which fails to provide sufficient space for permeating air and water for planting, and the box cannot be folded when not in use, so it is not easy to store, and greatly reduces its practicality.

To achieve the aforementioned objectives, the present disclosure provides a foldable stackable storage planter box structure, including:
a box, including a base, two side panels, two end panels; wherein two sides of the base are provided with the two side panels respectively which are inwardly folded to the top of the base and configured to be opposite to each other, two ends of the base are provided with the end panels which are disposed on the inner side of the side panel and inwardly folded and configured to be movable, the end panel are folded and disposed at the top of the base and the bottom the side panel, the base includes a plurality of penetrating drainage holes for permeating water, the base includes a plurality of bottom snap recesses formed at four corners of the bottom thereof, and the bottom edge of the two sides and two ends of the base are provided with at least one side snap protrusion and at least one end snap protrusion;
a support stand, installed at the top of the base of the box and arranged on the inner side of the vertical side panels and the end panel, and having a plurality of through holes for permeating water, and the bottom of the support stand including a plurality of lower supports for supporting the top of the base and defining a space; and
at least one filter fabric, disposed at the top of the support stand.

In the present disclosure, the side panel includes at least one side top recess formed at the top of the side panel and configured to be corresponsive to the side snap protrusion of the base, and the end panel includes at least one end top recess formed at the top of the end panel and configured to be corresponsive to the end snap protrusion of the base.

In the present disclosure, the base includes a plurality of side embedding recesses formed at the upper edge of two sides of the base and a plurality of bosses formed between the side embedding recesses, and the boss includes at least one positioning recess formed at the top of the boss; and the base includes a plurality of end embedding recesses formed at the top edge of the two ends of the base.

In the present disclosure the side panel includes a plurality of side embedding parts protruded from the bottom of the side panel and configured to be corresponsive to the side embedding recess of the base, and at least one positioning protrusion formed between the side embedding parts of the side panel and configured to be corresponsive to the positioning recess of the boss; the side panel includes a side folding plate bent from two ends of the side panel for blocking the end panel, the side folding plate includes at least one side buckle hole, and the side panel includes an inner retainer buckle disposed at the inner periphery of the side folding plate for blocking and fixing the end panel and providing elasticity.

In the present disclosure, the end panel includes a plurality of end embedding parts protruded from the bottom of the end panel and configured to be corresponsive to the end embedding recess of the base; and the end panel includes at least one end side buckle disposed on two sides of the end panel and configured to be corresponsive to the side buckle hole of the side folding plate of the side panel.

In the present disclosure, the height of the two sides of the base of the box is greater than the height of the two sides of the base two ends.

In the present disclosure, the base includes four footers installed at the bottom of four corners of the base respectively and a plurality of latches installed at the top of the footer and configured to be corresponsive to the bottom of the bottom snap recesses respectively.

In the present disclosure, the bottom of the footer is provided with a bottom plate.

Compared with the effects of the related art, the foldable stackable storage planter box structure of the present disclosure includes the base and its two sides and two ends movably connected to the side panel and the end panel respectively, wherein the top of the side panel and the top of the end panel are provided with the side top recess and the end top recess respectively, the two sides and the two ends of the base are provided with the side snap protrusion and the end snap protrusion respectively, the top of the base is provided with the support stand, and the top of the support stand is provided the filter fabric. Further, the end panel and the side panel folded inwardly or outwardly in a vertical manner and combined to provide a folded flat box or a vertically unfolded box. The box provides a space for placing a support stand and a filter fabric, and uses a side top recess of the side panel and an end top recess of the end panel to interconnect a side snap protrusion and an end snap protrusion formed at the bottom of another box, so as to achieve the effects of effectively enhancing the ease of use, saving space, and providing good transportation, storage and stacking stability. The present disclosure with novelty and inventiveness greatly expands the industrial utilization.

### BRIEF DESCRIPTION OF THE DRAWINGS

FIG. 1 is an exploded view of the present disclosure;

FIG. 2 is a perspective view of the present disclosure;

FIG. 3 is a cross-sectional of the present disclosure;

FIG. 4 is a perspective view of the present disclosure, viewing from another angle that showings the bottom of the present disclosure;

FIG. 5 is a schematic view showing a bottom snap recess of a base with a footer in accordance with an embodiment of the present disclosure;

FIG. 6 is a schematic view showing a box with an end panel and a side panel that are folded with each other into a flat shape in accordance with an embodiment of the present disclosure;

FIG. 7 is a schematic view showing a plurality of boxes stacked with one another in accordance with the present disclosure;

FIG. 8 is a schematic view showing a box having a support stand and a filter fabric disposed at the upper end of its base, filled with soil, and planted with plants in accordance with an embodiment of the present disclosure; and

FIG. 9 is a schematic view showing a box filled with soil and planted with plants, when water is passed through a filter fabric and a support stand and then discharged from the base in accordance with an embodiment of the present disclosure

### DESCRIPTION OF THE PREFERRED EMBODIMENTS

The objectives, technical contents and features of this disclosure will become apparent in the following detailed description of the preferred embodiments with reference to the accompanying drawings. It is noteworthy that the drawings used in the specification and subject matters of this disclosure are intended for illustrating the technical characteristics of this disclosure, but not necessarily to be drawn according to actual proportion and precise configuration. Therefore, the scope of this disclosure should not be limited to the proportion and configuration of the drawings.

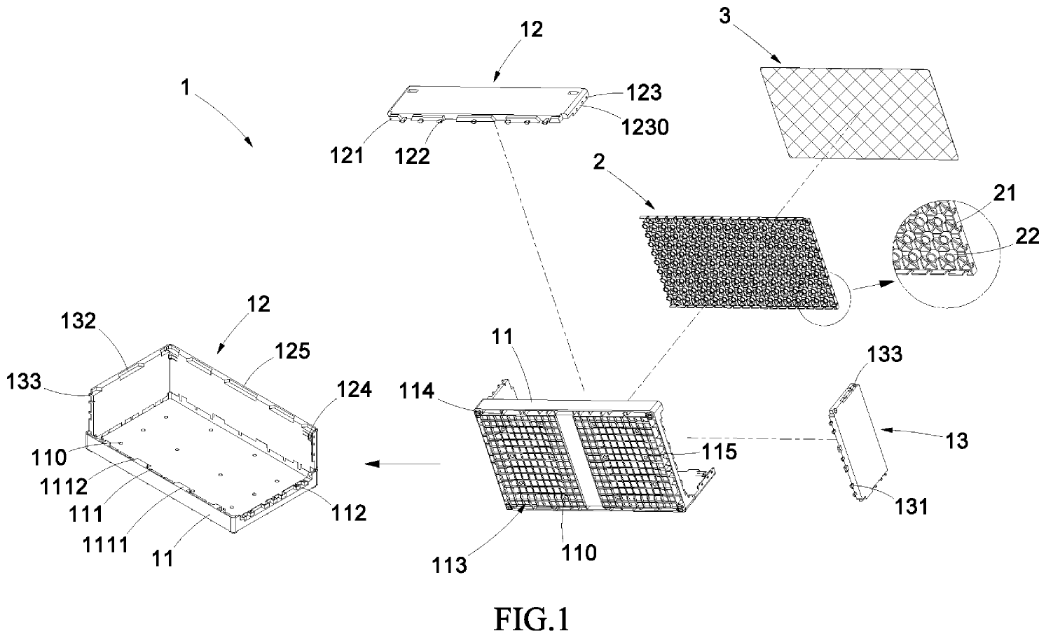

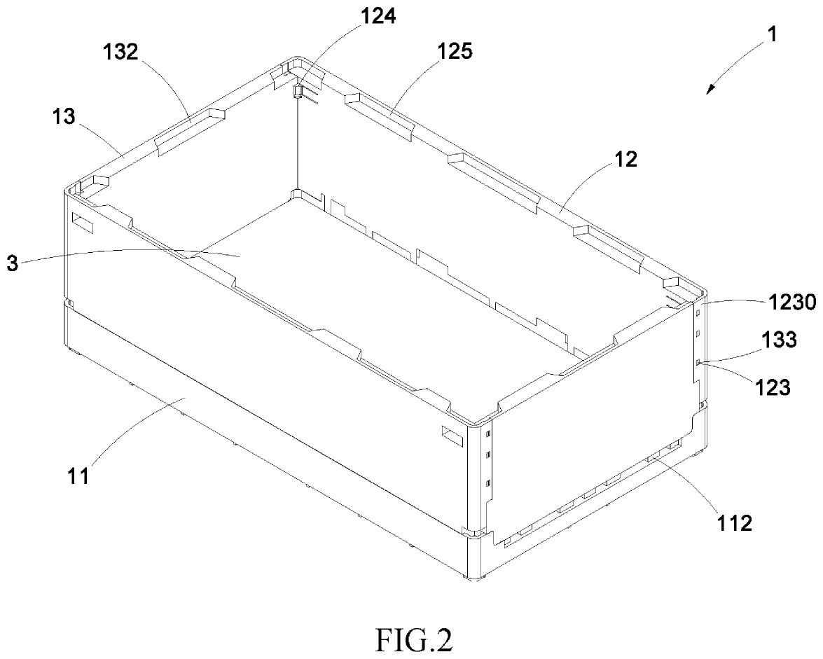

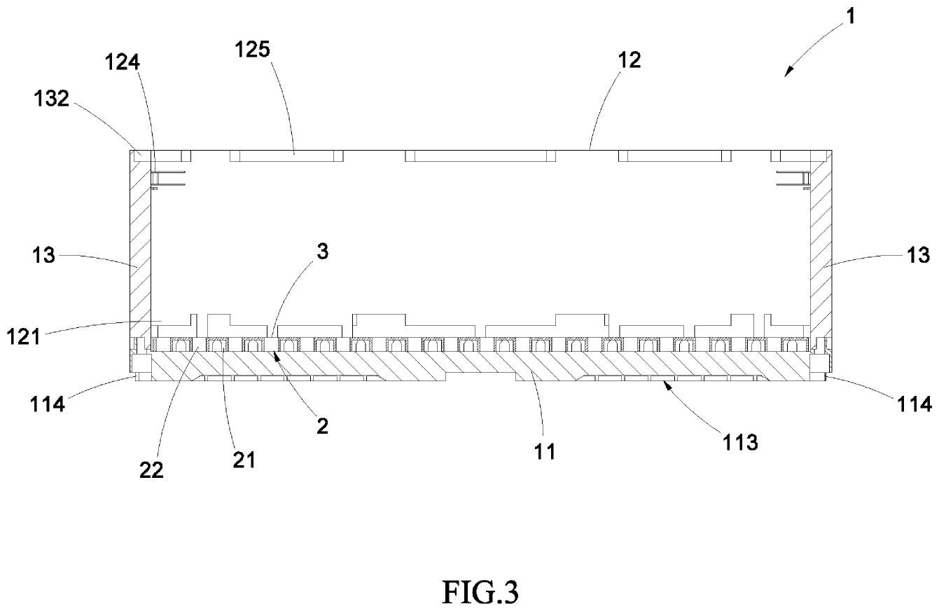

With reference to FIGS. 1, 2, 3, 4 and 5, 6 and 7 for the exploded view, the perspective view, the cross-sectional view, the perspective view viewing from another angle from the bottom, the schematic view of a bottom snap recess of the base with footers, the schematic view of a box with its end panel and side panel folded and stacked into a flat shape, and the schematic view of a multiple of boxes stacked on one another respectively, a foldable stackable storage planter box structure in accordance with a preferred embodiment of the present disclosure includes a box 1, a support stand 2, and at least one filter fabric 3.

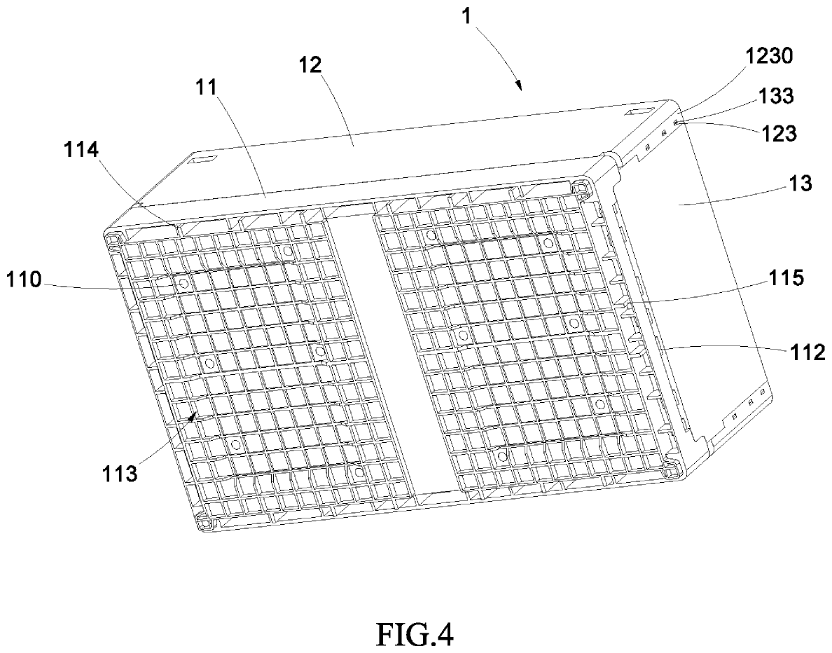

The box 1 includes a base 11, two side panels 12, two end panels 13. Two sides of the base 11 are provided with the two side panel 12 respectively which are inwardly folded to the top of the base 11 and configured to be opposite to each other, two ends of the base 11 are provided with the end panels 13 which are disposed on the inner side of the side panel 12 and inwardly folded and configured to be movable, the end panels 13 are folded and disposed at the top of the base 11 and the bottom of the side panel 12 respectively, the base 11 includes a plurality of penetrating drainage holes 110 for permeating water, the base 11 includes a plurality of bottom snap recesses 113 formed at the four corners of the bottom of the base 11 (as shown in FIG. 4), the base 11 includes at least one side snap protrusion 114 and at least one end snap protrusion 115 formed at the bottom edge of the two sides and the two ends; the top of the side panel 12 is provided with at least one side top recess 125 and configured to be corresponsive to the side snap protrusion 114, the top of the end panel 13 is provided with at least one end top recess 132 and configured to be corresponsive to the end snap protrusion 115 of the base 11 (as shown in FIG. 4); the top edges of two sides of the base 11 are provided with a plurality of side embedding recesses 111, a plurality of bosses 1111 is formed between the side embedding recesses 111, the tops of the bosses 1111 are provided with at least one positioning recess 1112; the top edges of two ends of the base 11 are provided with a plurality of end embedding recesses 112; the bottom of the side panel 12 is provided with a plurality of protruding side embedding parts 121 and configured to be corresponsive to the side embedding recesses 111 of the base 11 respectively, at least one positioning protrusion 122 is disposed between the side embedding parts 121 of the side panel 12 and configured to be corresponsive to the positioning recesses 1112 of the boss 1111 respectively; two ends of the side panel 12 are bent and provided with a side folding plate 1230 for stopping and blocking the end panel 13, the side folding plate 1230 includes at least one side buckle hole 123, the side panel 12 is provided with an inner retainer buckle 124 disposed at the inner edge of the side folding plate 1230 for blocking and fixing the end panel 13 and providing elasticity; the bottom of the end panel 13 is provided with a plurality of protruding end embedding parts 131 and configured to be corresponsive to the end embedding recesses 112 of the base 11 respectively; two sides of the end panel 13 are provided with at least one end side buckle 133 which is configured to be corresponsive to the side buckle hole 123 of the side folding plate 1230 of the side panel 12. In order to fold the base 11 with the side panel 12 and the end panel 13, the height of the two sides of the base 11 of the box 1 is greater than the height of the two ends of the base 11 (as shown in FIGS. 1, 2, 3 and 4).

The aforementioned support stand 2 is installed at the top of the base 11 of the box 1 and disposed at the vertical side panel 12 and the inner of the end panel 13, the support stand 2 includes a plurality of through holes 21 for permeating water, the bottom of the support stand 2 is provided with a plurality of lower supports 22 for supporting the top of the base 11 to define a space (as shown in FIGS. 1, 2, 3 and 4).

The aforementioned at least one filter fabric 3 is disposed at the top of the support stand 2 (as shown in FIGS. 1, 2, 3, and 4).

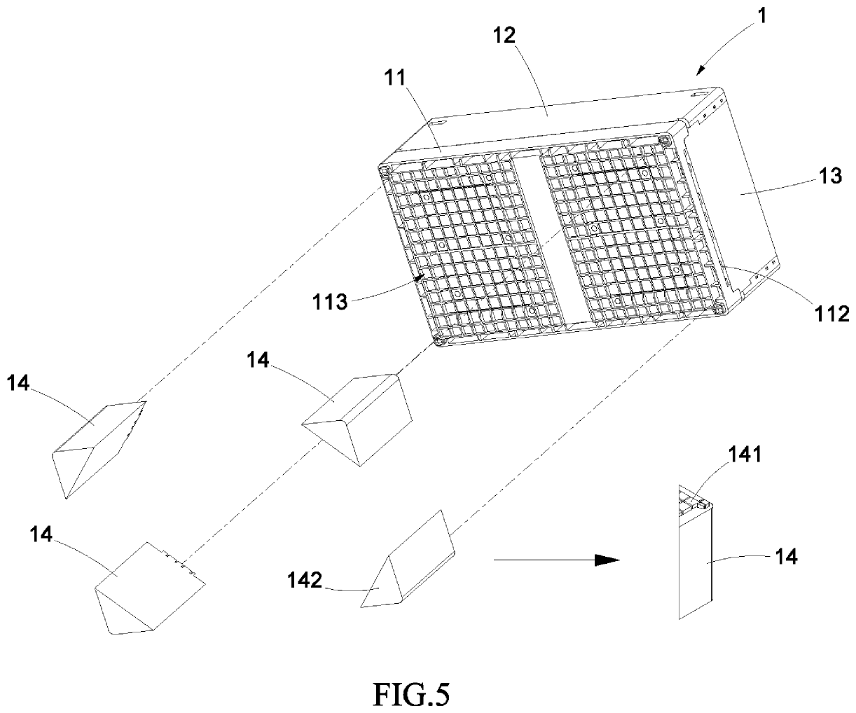

In the present disclosure, four corners of the bottom of the base 11 of the box 1 are provided with four footers 14 respectively, the tops of the footers 14 are provided with a plurality of latches 141 which are configured to be corresponsive to the bottom snap recesses 113 formed at the bottom of the base 11. The bottom of the footer 14 of the present disclosure is provided with a bottom plate 142 (as shown in FIG. 5). In this embodiment, the bottom snap recesses 113 of the base 11 are arranged in an L-shape, the shape of the footer 14 is also in the corresponding L-shape, and the bottom plate 142 is in a triangular shape, but the present disclosure is not limited to this shape only.

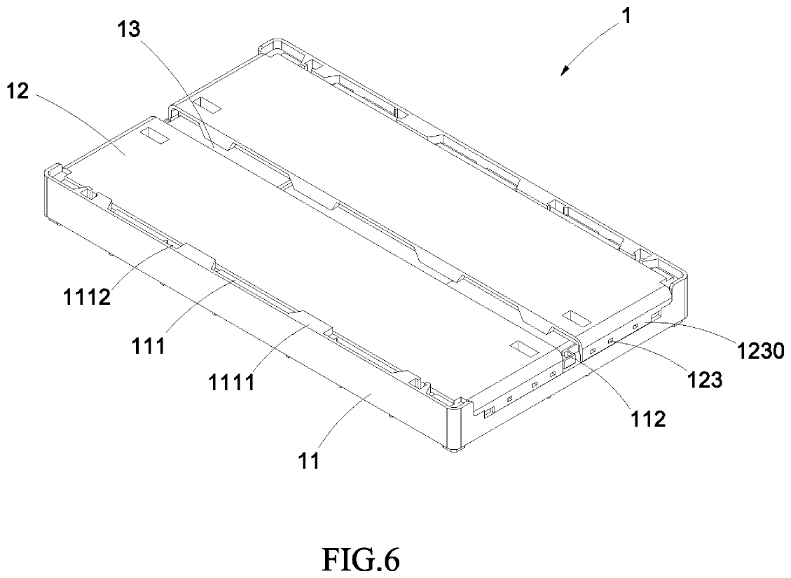

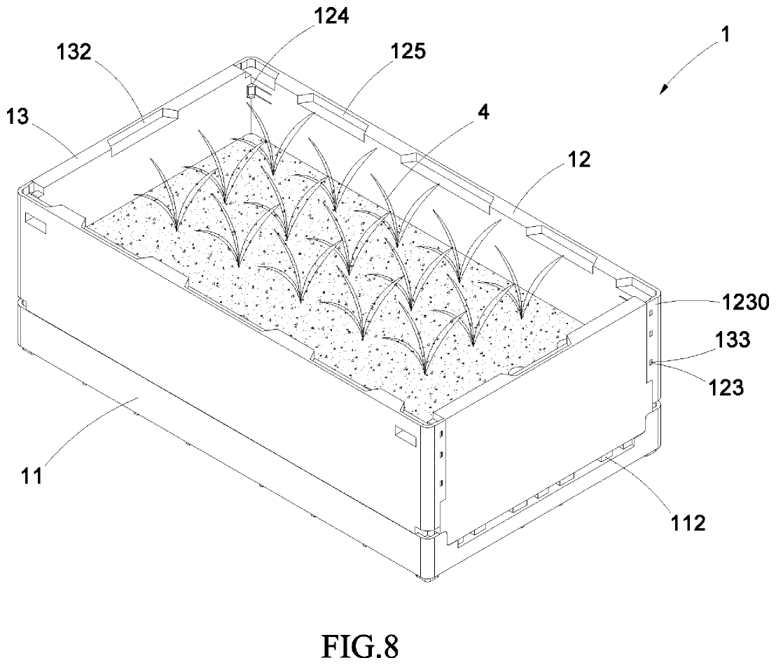

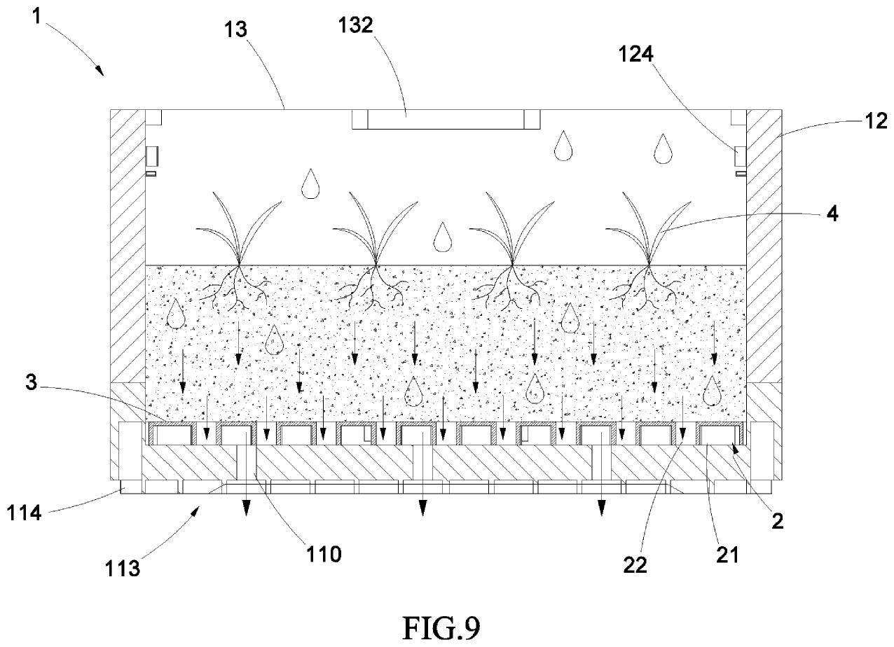

With reference to FIGS. 8 and 9 for the present disclosure for the schematic views of a box with a support stand and a filter fabric installed at the top of its base and soil and plants contained in the box and water passed through a filter fabric and a support stand and discharged from the base in accordance with the present disclosure, the use of the present disclosure is simple and easy. To fold and store the planter box, the support stand 2 and the filter fabric 3 are removed, and then the end panels 13 at two ends of the base 11 of the box 1 are folded inwardly, and the end panel 13 will be attached flatly to the top of the base 11, and then the side panel 12 is folded inwardly to flatly attach the side panel 12 to the top of the end panel 13 to form a flat shape (as shown in FIG. 6) to save space and facilitate storage and transportation. To unfold the planter box, the steps of the operating process are reversed, and the side panels 12 will be vertical to the top edges of the two sides of the base 11, the end panels 13 will also be vertical to the top edges of the two ends of the base 11 and disposed on the inner side of the side panel 12, the end side buckle 133 of the end panel 13 will be snapped into the side buckle hole 123 of the side folding plate 1230 on the two sides of the side panel 12, the positioning protrusion 122 at the bottom of the side panel 12 will be snapped into the positioning recess 1112 of the boss 1111 of the base 11, the end panels 13 will be blocked and fixed to the inner retainer buckle 124 of the side panel 12 and stopped between the side folding plates 1230; and then the support stand 2 and the filter fabric 3 are placed at the top of the base 11 before placing the plant 4 into the planter box (as shown in FIG. 8). When watering, excessive water will seep through the filter fabric 3 and pass through the support stand 2 with the through holes 21, and then discharged from the drainage hole 110 of the base 11 (as shown in FIG. 9).

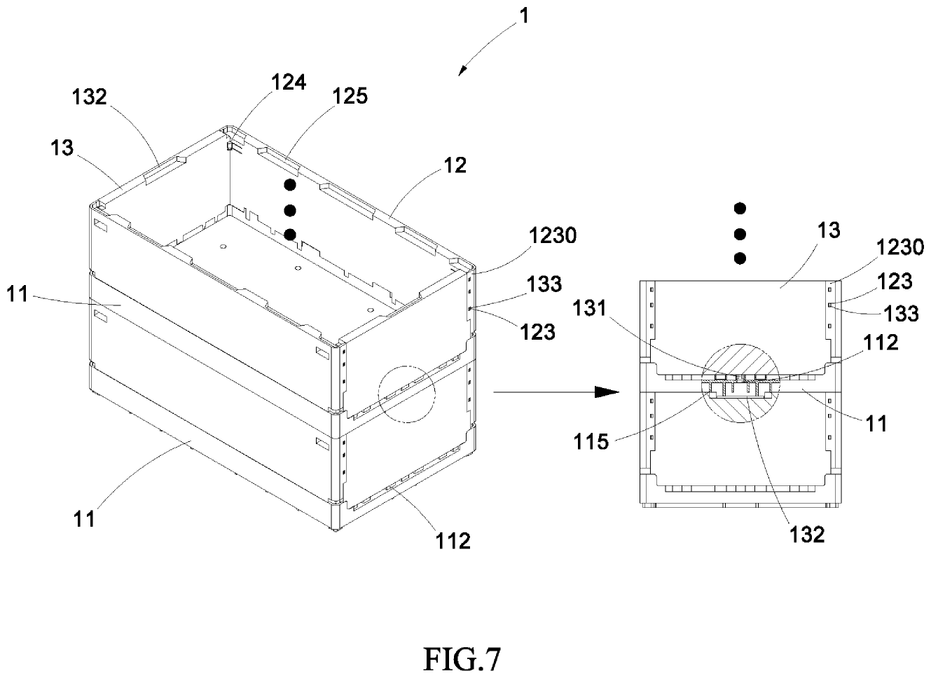

When it is necessary to stack the box 1 of each unit, the side top recess 125 formed at the top of the side panel 12 and the end top recess 132 formed at the top of the end panel 13 are embedded into the side snap protrusion 114 and the end snap protrusion 115 formed at the two sides and two ends of the base 11 of another unit of the box 1 for a stack (as shown in FIG. 7). In addition, the present disclosure can heighten the position of the box 1 by embedding the footers 14 into the bottom snap recesses 113 at the four corners of the bottom of the base 11 of the box 1, the top of the footer 14 is provided with the plurality of latches 141 which is embedded into the bottom snap recesses 113 of the base 11. The heightening effect can be achieved by the above interlocking (as shown in FIG. 5).

In the box 1 of the present disclosure, the base 11 and its two sides and two ends are connected with the side panel 12 and the end panel 13, the top of the side panel 12 and the top of the end panel 13 are provided with the side top recess 125 and the end top recess 132 respectively, and two sides and two ends of the base 11 are provided with the side snap protrusion 114 and the end snap protrusion 115 respectively, the top of the base 11 is provided with the support stand 2, the top of the support stand 2 is provided with the filter fabric 3. The end panel 13 and the side panel 12 are inwardly or outwardly fold into a vertical manner to form the box 1 in a flat folded form or a vertical unfolded form, and the support stand 2 and the filter fabric 3 are placed into the box 1. In the box 1 the side top recess 125 of the side panel 12 and the end top recess 132 of the end panel 13 are snapped into the side snap protrusion 114 and the end snap protrusion 115 of another unit of the box respectively to achieve the effects of enhancing the convenience of use, saving space, and provide good transportation, storage and stacking stability. The present disclosure with novelty and inventiveness greatly expands the industrial utilization.

In summation of the description above, this disclosure breaks through the related art and definitely achieves the desired improvement, and the disclosure is non-obvious, novel, and inventive, and complies with the patent application requirements, and thus is duly filed for patent application.

While the disclosure has been described by means of specific embodiments, it is to be understood that the disclosure is not limited thereto. To the contrary, numerous modifications and variations could be made thereto by those skilled in the art without departing from the scope and spirit of the disclosure set forth in the claims.

What is claimed is:

1. A foldable stackable storage planter box structure, comprising:
a box, comprising a base, two side panels, two end panels; wherein two sides of the base are provided with the two side panels respectively which are inwardly folded to the top of the base and configured to be opposite to each other, two ends of the base are provided with the end panels which are disposed on the inner side of the side panel and inwardly folded and configured to be movable, the end panels are folded and disposed at the top of the base and the bottom of the side panel respectively, the base comprises a plurality of penetrating drainage holes for permeating water, the base comprises a plurality of bottom snap recesses formed at four corners of the bottom thereof, and the bottom edge of the two sides and two ends of the base are provided with at least one side snap protrusion and at least one end snap protrusion;
a support stand, installed at the top of the base of the box and arranged on the inner side of the vertical side panels and the end panel, and having a plurality of through holes for permeating water, and the bottom of the support stand comprising a plurality of lower supports for supporting the top of the base and defining a space; and
at least one filter fabric, disposed at the top of the support stand.

2. The foldable stackable storage planter box structure according to claim 1, wherein the side panel comprises at least one side top recess formed at the top thereof and configured to be corresponsive to the side snap protrusion of the base, and the end panel comprises at least one end top recess formed at the top thereof and configured to be corresponsive to the end snap protrusion of the base.

3. The foldable stackable storage planter box structure according to claim 2, wherein the base comprises a plurality of side embedding recesses formed at the upper edge of two sides thereof, a plurality of bosses formed between the side embedding recesses, and the boss comprises at least one positioning recess formed at the top thereof; and the base comprises a plurality of end embedding recesses formed at the top edge of the two ends thereof.

4. The foldable stackable storage planter box structure according to claim 3, wherein the side panel comprises a plurality of side embedding parts protruded from the bottom thereof and configured to be corresponsive to the side embedding recess of the base, and at least one positioning protrusion formed between the side embedding parts of the side panel and configured to be corresponsive to the positioning recess of the boss; the side panel comprises a side folding plate bent from two ends thereof for blocking the end panel, the side folding plate comprises at least one side buckle hole, and the side panel comprises an inner retainer buckle disposed at the inner periphery of the side folding plate for blocking and fixing the end panel and providing elasticity.

5. The foldable stackable storage planter box structure according to claim 4, wherein the end panel comprises a plurality of end embedding parts protruded from the bottom thereof and configured to be corresponsive to the end embedding recess of the base; and the end panel comprises at least one end side buckle disposed on two sides thereof and configured to be corresponsive to the side buckle hole of the side folding plate of the side panel.

6. The foldable stackable storage planter box structure according to claim 1, wherein the height of the two sides of the base of the box is greater than the height of the two sides of the base two ends.

7. The foldable stackable storage planter box structure according to claim 2, wherein the height of the two sides of the base of the box is greater than the height of the two sides of the base two ends.

8. The foldable stackable storage planter box structure according to claim 3, wherein the height of the two sides of the base of the box is greater than the height of the two sides of the base two ends.

9. The foldable stackable storage planter box structure according to claim 4, wherein the height of the two sides of the base of the box is greater than the height of the two sides of the base two ends.

10. The foldable stackable storage planter box structure according to claim 5, wherein the height of the two sides of the base of the box is greater than the height of the two sides of the base two ends.

11. The foldable stackable storage planter box structure according to claim 5, wherein the base comprises four footers installed at the bottom of four corners thereof respectively, and a plurality of latches installed at the top of the footer and configured to be corresponsive to the bottom of the bottom snap recesses respectively.

12. The foldable stackable storage planter box structure according to claim 11, wherein the footer comprises a bottom plate disposed at the bottom thereof.
